(19) United States
(12) Patent Application Publication
(10) Pub. No.: US 2007/0031716 A1
(43) Pub. Date: Feb. 8, 2007

(54) Process for making cation exchange membranes with reduced methanol permeability

(76) Inventor: Raj G. Rajendran, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/198,461

(22) Filed: Aug. 5, 2005

(51) Int. Cl. H01M 8/10; C08J 5/22

(52) U.S. Cl. 429/33; 521/27; 429/316; 429/314

(57) ABSTRACT

The present invention provides for a process to prepare a solid polymer electrolyte membrane having an ionomer having imbibed therein a polymer is selected from the group consisting of a polyamine, a polyvinyl amine, and derivatives thereof, wherein the membrane is irradiated after the impregnation. The invention also provides a catalyst coated membrane and a fuel cell having this solid polymer electrolyte membrane.

### FIELD OF INVENTION

The present invention relates for a direct methanol fuel cell that employs a solid polymer electrolyte membrane, and more particularly relates to certain solid polymer electrolyte membrane compositions.

### BACKGROUND

Direct methanol fuel cells (DMFCs), fuel cell in which the anode is fed directly with liquid or vaporous methanol, have been under development for a considerable period of time, and are well-known in the art. See for example Baldauf et al, J. Power Sources, vol. 84, (1999), Pages 161-166. One essential component in a direct methanol, or any, fuel cell is the membrane separator.

It has long been known in the art to form ionically conducting polymer electrolyte membranes and gels from organic polymers containing ionic pendant groups, especially fluorinated ionomers such as Nafion®) perfluoroionomer membranes available from E. I. du Pont de Nemours and Company, Wilmington Del.

DMFCs employing ionomeric polymer electrolyte membranes as separators are known to exhibit high methanol cross-over—the transport of methanol from anode to the cathode by diffusion and electro-osmotic drag through the membrane. This methanol cross-over essentially represents a fuel leak, greatly decreasing the efficiency of the fuel cell. In addition, the presence of methanol at the cathode interferes with the cathode reaction kinetics, with the methanol itself undergoing oxidation, and, in sufficient volume, floods the cathode and shuts down the fuel cell altogether. Methanol cross-over occurs primarily as a result of the high solubility of methanol in the ionomeric membranes of the art.

Li et al, WO 98/42037, discloses polymer electrolyte blends in batteries. Disclosed are blends of polybenzimidazoles with Nafion®) and other polymers in concentration ratios of ca. 1:1. Preferred are blends of polybenzimidazoles and polyacrylamides. Polyvinylpyrrolidone and polyethyleneimine are also disclosed.

Howard, WO 03/034529 provides for a solid polymer electrolyte membrane comprising a fluorinated ionomer having imbibed therein a non-fluorinated, non-ionomeric polymer, that is selected from the group consisting of a polyamine, a polyvinyl amine, and derivatives thereof. However, in some cases the polyamine can leach from the membrane if it is not strongly immobilized in the parent membrane structure.

Pickup et al, Journal of the Electrochemical Society (2003), 150(10), C735-C739, impregnated perfluorosulphonic acid membranes with polypyrrole by in situ polymerization using a hydrogen peroxide or iron (Fe³⁺) oxidant. The membranes reduced the crossover of methanol in direct methanol fuel cells but also had increased ionic resistance.

It is of considerable interest in the art to identify ways to reduce methanol cross-over in ionomeric membranes while entailing as small as possible cost in conductivity.

### SUMMARY OF THE INVENTION

The invention is directed to a process to prepare a solid polymer electrolyte membrane comprising: impregnating a film of an ionomer with a solution comprised of a solvent for the polyamine; and irradiating said film.

In one aspect of the invention, the ionomer is a fluorinated ionomer.

Another aspect of the invention is a membrane made by the process described above.

Yet other aspects of the invention include a membrane and electrode assembly comprising a layer containing electrically conductive, catalytically active particles formed on the surface of a membrane made by the process described above, an electrochemical cell comprising the membrane made by the process described above, and a fuel cell comprising the membrane made by the process described above.

### BRIEF DESCRIPTION OF THE FIGURES

FIG. 1 is a schematic illustration of a single cell assembly.

FIG. 2 is a schematic illustration of a fuel cell test station.

### DETAILED DESCRIPTION OF THE INVENTION

The invention is directed to a process to prepare a solid polymer electrolyte membrane comprising: impregnating a film of an ionomer with a solution comprised of polyamine dissolved in a suitable solvent; and irradiating said film. Typically, the total radiation dose is in the range of 1 to 150 KGy. The polyamine is immobilized, possibly by crosslinking, within the membrane after impregnation, not before, thereby improving the retention to the ionomer of the polyamine. It is found that a membrane prepared by this process is useful in electrochemical cells, particularly in fuel cells, and provides a reduction in methanol permeability in direct methanol fuel cells at relatively modest cost, if any, in conductivity and therefore in power density.

Any direct methanol fuel cell known in the art, of the type provided with an ionomeric polymer electrolyte membrane may be employed in the present invention. It is by the substitution of a membrane comprising a ionomer, prepared according to the teachings of the present invention, for the ionomeric membrane of the art that the benefits of the present invention are realized.

One of ordinary skill in the art will understand that the film or sheet structure will have utility in packaging, in non-electrochemical membrane applications, as an adhesive or other functional layer in a multilayer film or sheet structure, and other classic applications for polymer films and sheets which are outside electrochemistry. For the purposes of the present invention, the term “membrane,” a term of art in common use in the fuel cell art is synonymous with the terms “film” or “sheet” which are terms of art in more general usage but refer to the same articles.

Polyamines

For the purposes of the present invention the term “polyamine” refers to polymers having an amine functionality in the monomer unit, either incorporated into the backbone, as in polyalkyleneimines, or in a pendant group as in polyvinyl amines. The pendant group containing the amine functionality may be linear or cyclic, and may be substituted with other functionalities. The term “polyamine” will be employed to encompass polymers variously known as polyamines, polyamides, polyimines, polyimides, and derivatives thereof, and polyvinyl amines, amides, imines, and imides, and derivatives thereof. By “derivatives thereof” it is meant C—N(—R)—C wherein R is R′—C(═O)—; R′SO₂—; and wherein R or R′ is alkyl of 1 to 16 carbon atoms, more typically 1 to 5 carbon atoms, and aryl of 6-20 carbon atoms, more typically 6 to 8 carbon atoms. In one embodiment of the invention the polyamine is polyvinylpyrrolidone (PVP) or polyethyleneimine (PEI). Any polymer molecular weight can be used in the instant invention, including low molecular weight oligomers. In one embodiment the polymer has a molecular weight of at least 2000.

Lonomers

Following the practice of the art, in the present invention, the term “ionomer” is used to refer to a polymeric material having a pendant group with a terminal ionic group. The terminal ionic group may be an acid or a salt thereof as might be encountered in an intermediate stage of fabrication or production of a fuel cell. Proper operation of an electrochemical cell may require that the ionomer be in acid form. The polymer may be thus be hydrolyzed and acid exchanged to the acid form either before or after irradiation.

An ionomer suitable for the practice of the invention has cation exchange groups that can transport protons across the membrane. The cation exchange groups are acids that can be selected from the group consisting of sulfonic, carboxylic, boronic, phosphonic, imide, methide, sulfonimide and sulfonamide groups. Typically, the ionomer has sulfonic acid and/or carboxylic acid groups. Various known cation exchange ionomers can be used including ionomeric derivatives of trifluoroethylene, tetrafluoroethylene, styrene-divinylbenzene, alpha, beta, beta-trifluorostyrene, etc., in which cation exchange groups have been introduced. Alpha, beta, beta-trifluorostyrene polymers useful for the practice of the invention are disclosed in U.S. Pat. No 5,422,411.

In one embodiment, the ionomer is fluorinated. The term “fluorinated ionomer” means ionomers that have at least 8 mol %, more typically at least 14 mol % of monomer units having a fluorinated pendant group with a terminal ionic group, preferably a sulfonic acid or sulfonate salt. A “polymeric precursor” to an ionomer suitable for use in the present invention preferably comprises a sulfonyl fluoride end-group, which when subject to hydrolysis under alkaline conditions, according to well-known methods in the art, is converted into a sulfonate salt and further acid exchange to sulfonic acid.

Well-known so-called fluorinated ionomer membranes suitable for the present invention and in widespread commercial use are Nafion® perfluoroionomer membranes available from E. I. du Pont de Nemours and Company, Wilmington DE. Nafion® is formed by copolymerizing tetrafluoroethylene (TFE) with perfluoro(3,6-dioxa-4-methyl-7-octenesulfonyl fluoride), as disclosed in U.S. Pat. No. 3,282,875. Other well-known perfluoroionomer membranes are copolymers of TFE with perfluoro(3-oxa-4-pentene sulfonyl fluoride), as disclosed in U.S. Pat. No. 4,358,545. The copolymers so formed are converted to the ionomeric form by hydrolysis, typically by exposure to an appropriate aqueous base, as disclosed in U.S. Pat. No. 3,282,875. Lithium, sodium and potassium are all well known in the art as suitable cations for the above cited ionomers.

Other fluorinated ionomer membranes known in the art that are suitable for the present invention are those described in WO 9952954, WO 0024709, WO 0077057, and U.S. Pat. No. 6,025,092.

In one embodiment of the invention the fluorinated ionomer is a highly fluorinated sulfonic acid polymer. The term “highly fluorinated” means that at least 90% of the total number of halogen and hydrogen atoms are fluorine atoms. In another embodiment, the polymer is perfluorinated, which means 100% of the total number of halogen and hydrogen atoms on the backbone are fluorine atoms.

In another embodiment of the invention, the highly fluorinated sulfonic acid polymer comprises a polymer backbone and recurring side chains attached to the backbone with the side chains carrying the sulfonyl fluoride groups (—SO₂F). For example, it is preferred to use copolymers of a first fluorinated vinyl monomer and a second fluorinated vinyl monomer having the sulfonyl fluoride group. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures thereof. Possible second monomers include a variety of fluorinated vinyl ethers with a sulfonyl fluoride group.

Another embodiment for use in the present invention includes highly fluorinated polymers with a highly fluorinated carbon backbone and a side chain represented by the formula —(OCF₂CFR_{f})ₐ—OCF₂CFR′_{f}SO₂F, wherein R_{f} and R′_{f} are independently selected from F, Cl or a perfluorinated alkyl group having 1 to 10 carbon atoms, and a =0, 1 or 2. Other embodiments include, for example, polymers disclosed in U.S. Pat. Nos.4,358,545 and 4,940,525. The polymer can also comprise a perfluorocarbon backbone and the side chain is represented by the formula —O—CF₂CF(CF₃)—Q—CF₂CF₂SO₂F. Polymers of this type are disclosed in U.S. Pat. No.3,282,875 The highly fluorinated sulfonic acid polymer in sulfonyl fluoride form is thermoplastic and it is advantageous to make the membrane or film for use in the process by conventional melt extrusion techniques. Solution film casting techniques using suitable solvents can also be used.

If desired, the membrane can be a laminate of two polymers such as two highly fluorinated polymers having different ion exchange capacities. Such films can be made by laminating two membranes or co-extruding a film with the two polymer layers. Alternatively, one or both of the laminate components can be cast from solution or dispersion. When the membrane is a laminate, the chemical identities of the monomer units in the additional cation exchange polymer can independently be the same as or different from the identities of the analogous monomer units of the first cation exchange polymer.

The thickness of the membrane can be varied as desired for a particular electrochemical cell application. Typically, the thickness of the membrane is less than about 250 μm, more typically in the range of about 25 μm to about 175 μm.

The membrane may optionally include a porous support for the purposes of improving mechanical properties, for decreasing cost and/or other reasons. The porous support of the membrane may be made from a wide range of components. The porous support of the present invention may be made from a hydrocarbon such as a polyolefin, e.g., polyethylene, polypropylene, polybutylene, copolymers of those materials, and the like. Perhalogenated polymers such as polychlorotrifluoroethylene may also be used.

For resistance to thermal and chemical degradation, the support preferably is made of a highly fluorinated polymer, most preferably a perfluorinated polymer. For example, the polymer for the porous support can be a microporous film of polytetrafluoroethylene (PTFE) or a copolymer of tetrafluoroethylene with CF₂═CFCₙF₂ₙ₊₁(n=1 to 5) or (CF₂═CFO—(CF₂C(CF₃)FO)ₘCₙF₂ₙ₊₁(m=0 to 15, n=1 to 15).

Microporous PTFE films and sheeting are known which are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids.

Alternatively, the porous support may be a fabric made from fibers of the polymers discussed above woven using various weaves such as the plain weave, basket weave, leno weave, or others.

A film can be made using the porous support by coating the cation exchange polymer on the support so that the coating is on the outside surfaces as well as being distributed through the internal pores of the support. This may be accomplished by impregnating the porous support solution with the cation exchange polymer in sulfonyl fluoride form using a solvent which is not harmful to the polymer of the support under the impregnation conditions and which can form a thin, even coating of the cation exchange polymer on the support. Alternately or in addition to impregnation, thin films of the ion exchange polymer can be laminated to one or both sides of the porous support. For a film made by impregnation of a porous support, laminating a thin film is advantageous for preventing bulk flow through the membrane which can occur if large pores remain in the film.

Description of Process

The membrane is prepared by the impregnation of the ionomer film with a solution of a polyamine dissolved in a suitable solvent or mixture of solvents. By “polyamine” is also meant a mixture of one of more polyamines. The solvent for the polyamine is any in which a sufficient amount of the polyamine or derivatives thereof can be dissolved, and is not detrimental to the polyamine, polyvinyl amine, or derivatives, or the fluorinated ionomer. The solvent may be a single solvent or a mixture of solvents. In one embodiment the solvent, or one of the solvents in the mixture, also functions as a swelling agent for the ionomer. The solvent typically comprises one or more of water, an alcohol, or an ether.

Impregnation, also known as imbibing or absorbing, means that a portion of the polyamine is absorbed by or taken into the ionomer film. The impregnation is performed by soaking the film in the solution for the polyamine for a period of time sufficient to accumulate the desired concentration of polyamine within the film. After impregnating, the polyamine may typically be present in an amount of about 0.1 to about 25% by weight based on the weight of the film, more typically about 0.1 to about 10% or about 0.1 to about 5%.

In another embodiment, the polymer may be formed in-situ by impregnating the ionomer film with the a solution of the corresponding monomer or low molecular weight oligomer. Polymerization can occur either before or during the irradiation step.

In one embodiment the solvent is a water or a mixture of tetrahydrofuran (THF) and water. The polyamine, polyvinyl amine, or derivative is dissolved in the THF/H₂O mixture, and then a preformed membrane of the ionomer is immersed in the solution for a period of up to several hours in order to achieve the desired level of the polyamine polymer in the ionomer.

The temperature at which the impregnation is performed can vary depending on many factors, such as the thickness of ionomer membrane, desired concentration of non-ionomeric polymer in the above solution mixture, choice of solvent, and targeted amount of non-ionomeric polymer in the membrane. The process can be conducted at any temperature above the freezing point of the solvent and typically up to 100° C.; more typically at up to 70° C. or at room temperature.

After the film is impregnated, the film is dried and irradiated. By “irradiating” it is meant subjecting the film to ionizing radiation, such as but not limited to gamma radiation, beta radiation, also known as electron beam radiation, and x-ray.

Preferably, a source of non-spark-producing ionizing radiation is employed. The sources of this type of radiation include, but are not limited to (1) gamma sources, such as Co-60 and Cs-137, (2) beta sources (often referred to as electron beam accelerators or linear accelerators, and (3) x-rays. Ionizing radiation produces free radicals in the material being irradiated. The behavior of the free radicals produced is determined by the nature of the absorbing medium. The main difference between these three sources is the manner in which the radiation travels through the material being irradiated.

The most common sources of gamma radiation are Co-60 and Cs-137. Co-60 is made by pre-forming non-radioactive Co into rods or bars, then subjecting them to a neutron source such as the neutrons produced in a nuclear power plant.

Gamma radiation is emitted in a complete sphere, requiring the target material to completely surround the source if all of the irradiation is to be utilized. Gamma radiation is absorbed on a logarithmic basis as it travels in a material. In order to get a more uniform dose in the material, double sided exposure may be used, but is not necessary with a relatively thin material such as a chloralkali membrane. Gamma rays have a major advantage with better penetration, although this is less important in irradiating thin membranes.

The major disadvantages of radioactive sources are (1) high maintenance cost (replacement of source material), (2) the need for extreme safety precautions, (3) relatively low dose rate, and (4) the problems associated with transporting, storing, and disposing of highly radioactive substances. In addition, since the radioactive decay cannot be controlled (turned on and off) the facility must be operated continuously to realize a high efficiency.

X-rays are produced when high energy electrons are used to bombard metals. The efficiency of the x-ray source is determined by the molecular or atomic weight of the target and by the energy (accelerating voltage) of the electrons. The higher the molecular weight of the target material, the greater the efficiency. The efficiency is also proportional to the accelerating voltage. The penetration characteristics of x-rays are 5-20% greater than those of gamma rays.

The source of beta radiation is an electron beam accelerator. Electrons can be accelerated by (1) high DC voltages, (2) electric pulses, (3) magnetic pulses, or (4) a combination of these three. COCKCROFT-WALTON, isolated core, resonant transformer, DYNAMITRON (high voltage generated by a set of cascade rectifiers coupled to an oscillator), KLYSTRON (evacuated electron beam generator) and linacs are some of the names given to the techniques of producing high voltages. Absorption of high energy electrons in material is such that 90% of the beam energy may be used with a maximum to minimum dose ratio of 1.4 using a single pass under the beam.

The main advantages of the electron beam accelerators are the (1) high power and high throughput, (2) relatively low unit cost, (3) high dose rate, and (4) intrinsic safety. In addition, since electron accelerators may be turned off, the facilities do not have to be operated continuously. The main disadvantage of electron beam accelerators is the relatively small penetration of the electrons, about 2.1 cm in water for a 5 megarad source. This is not a significant disadvantage for irradiation of membranes, which are thin. Therefore, electron beam accelerators are the preferred source of ionizing radiation for this invention.

In the irradiation process, the membrane is typically exposed to irradiation with a total radiation dose typically about 1 to 150 KGy; more typically about 20-80 KGy, and even more typically about 40-80 KGy. The total dosage of radiation is a function of the time of each exposure, the dose rate, and the number of exposures. Preferably the number of exposures should be low, most preferably one. The dose rate will depend on the type of radiation used, the device used to generate the radiation, and the energy input to the source of radiation. For a given dose rate, the time of exposure can be varied to provide the preferred total dosage. A preferred way of controlling the time of exposure is to vary the speed of a conveyor system carrying the membrane through the irradiation zone.

The irradiation may be performed under vacuum or under an atmosphere. The atmosphere may be inert, such as nitrogen, or may more typically be ambient air.

The membranes may also be irradiated in a so-called “shield pack” or a package or container which is not effected by the radiation. Such a package or container prevents damage to the membrane from excessive handling. The package can be made from any material which is workable at radiation levels but will not block radiation. Typically the packages are made from a metal, such as but not limited to aluminum.

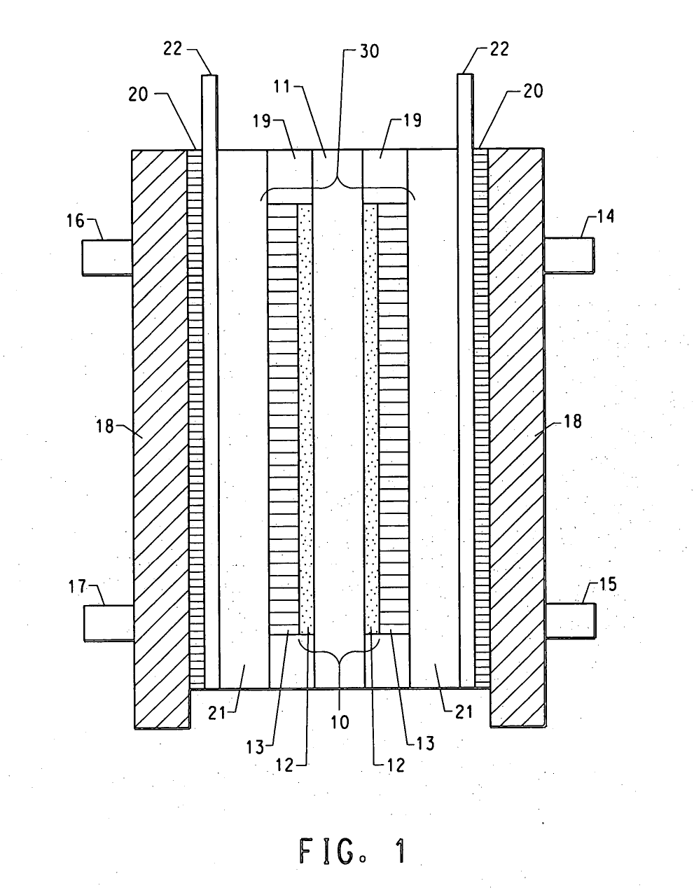

One of skill in the art will recognize that the polymer electrolyte membrane compositions of the invention wherein the membrane comprises polyamine will have utility in hydrogen fuel cells, including reformed hydrogen fuel cells, as well as in direct methanol fuel cells. Hydrogen fuel cells are well known in the art. Use of the ionomeric polymer membrane of the instant invention is contemplated in any or all hydrogen fuel cell designs. The specific design of and materials suitable for hydrogen fuel cells are largely encompassed by the following discussion that is primarily aimed at direct methanol fuel cells. That is to say, a hydrogen fuel cell must have an anode, a cathode, a separator, an electrolyte, a hydrogen feed, an oxygen feed, a means for connecting to the outside, and such other components as are indicated in FIG. 1 with the substitution of hydrogen for methanol. One of ordinary skill will recognize that for the purpose of the present invention, a hydrogen fuel cell includes a reformed hydrogen fuel cell.

Membrane Electrode Assemblies (MEAs) and Electrochemical Cells

One embodiment of a fuel cell suitable for the practice of the present invention is shown in FIG. 1. While the cell depicted represents a single-cell assembly such as that employed in determining some of the results herein, one of skill in the art will recognize that all of the essential elements of a direct methanol fuel cell are shown therein in schematic form.

An ionomeric polymer electrolyte membrane of the invention, 11, is used to form a membrane electrode assembly, 30, (MEA) by combining it with a catalyst layer, 12, comprising a catalyst, e.g. platinum, unsupported or supported on carbon particles, a binder such as Nafion®, and a gas diffusion backing, 13. The ionomeric polymer electrolyte membrane of the invention, 11, with a catalyst layer, 12, forms a catalyst coated membrane, 10, (CCM). The gas diffusion backing may comprise carbon paper which may be treated with a fluoropolymer and/or coated with a gas diffusion layer comprising carbon particles and a polymeric binder to form a membrane electrode assembly (MEA). The fuel cell is further provided with an inlet, 14, for fuel, such as liquid or gaseous alcohols, e.g. methanol and ethanol; or ethers such as diethyl ether, etc., an anode outlet, 15, a cathode gas inlet, 16, a cathode gas outlet, 17, aluminum end blocks, 18, tied together with tie rods (not shown), a gasket 19, for sealing, an electrically insulating layer, 20, and graphite current collector blocks with flow fields for gas distribution, 21, and gold plated current collectors, 22.

The fuel cell utilizes a fuel source that may be in the liquid or gaseous phase, and may comprise an alcohol or ether. Typically a methanol/water solution is supplied to the anode compartment and air or oxygen supplied to the cathode compartment. The ionomeric polymer electrolyte membrane serves as an electrolyte for proton exchange and separates the anode compartment from the cathode compartment. A porous anode current collector, and a porous cathode current collector are provided to conduct current from the cell. A catalyst layer that functions as the cathode is in contact with and between the cathode-facing surface of the membrane and the cathode current collector. A catalyst layer that functions as the anode is disposed between and is in contact with the anode-facing surface of the membrane and anode current collector. The cathode current collector is electrically connected to a positive terminal and the anode current collector is electrically connected to a negative terminal.

The catalyst layers may be made from well-known electrically conductive, catalytically active particles or materials and may be made by methods well known in the art. The catalyst layer may be formed as a film of a polymer that serves as a binder for the catalyst particles. The binder polymer can be a hydrophobic polymer, a hydrophilic polymer or a mixture of such polymers. Preferably, the binder polymer is an ionomer and most preferably is the same ionomer as in the membrane.

For example, in a catalyst layer using a perfluorinated sulfonic acid polymer membrane and a platinum catalyst, the binder polymer can also be perfluorinated sulfonic acid polymer and the catalyst can be a platinum catalyst supported on carbon particles. In the catalyst layers, the particles are typically dispersed uniformly in the polymer to assure that a uniform and controlled depth of the catalyst is maintained, preferably at a high volume density. It is typical that the particles be in contact with adjacent particles to form a low resistance conductive path through catalyst layer. The connectivity of the catalyst particles provides the pathway for electronic conduction and the network formed by the binder ionomer provides the pathway for proton conduction.

The catalyst layers formed on the membrane should be porous so that they are readily permeable to the gases/liquids that are consumed and produced in cell. The average pore diameter is preferably in the range of about 0.01 to about 50 μm, most preferably about 0.1 to about 30 μm. The porosity is generally in a range of about 10 to about 99%, preferably about 10 to about 60%.

The catalyst layers are preferably formed using an “ink”, i.e., a solution of the binder polymer and the catalyst particles, which is used to apply a coating to the membrane. The binder polymer may be in the ionomeric (proton) form or in the sulfonyl fluoride (precursor) form. When the binder polymer is in the proton form the preferred solvent is a mixture of water and alcohol. When the binder polymer is in the precursor form the preferred solvent is a perfluorinated solvent (such as FC-40 made by 3M).

The viscosity of the ink (when the binder is in the proton form) is preferably controlled in a range of 1 to 102 poises especially about 102 poises before printing. The viscosity may be controlled by:
(i) particle size selection,
(ii) the composition of the catalytically active particles and binder,
(iii) adjusting the water content (if present), or
(iv) preferably by incorporating a viscosity regulating agent such as carboxymethyl cellulose, methyl cellulose, hydroxyethyl cellulose, and cellulose and polyethyleneglycol, polyvinyl alcohol, polyvinyl pyrrolidone, sodium polyacrylate and polymethyl vinyl ether.

The area of the membrane to be coated with the ink may be the entire area or only a select portion of the surface of the membrane. The catalyst ink may be deposited upon the surface of the membrane by any suitable technique including spreading it with a knife or blade, brushing, pouring, metering bars, spraying and the like. The catalyst layer may also be applied by decal transfer, screen printing, pad printing or by application from a printing plate, such as a flexographic printing plate.

If desired, the coatings are built up to the thickness desired by repetitive application. The desired loading of catalyst upon the membrane can be predetermined, and the specific amount of catalyst material can be deposited upon the surface of the membrane so that no excess catalyst is applied. The catalyst particles are preferably deposited upon the surface of a membrane in a range from about 0.2 mg/cm² to about 20 mg/cm².

Typically a screen printing process is used for applying the catalyst layers to the membrane with a screen having a mesh number of about 10 to about 2400, more typically a mesh number of about 50 to about 1000, and a thickness in the range of about 1 to about 500 micrometers. The mesh and the thickness of the screen, and viscosity of the ink are selected to give electrode thickness ranging from about 1 micron to about 50 microns, more particularly about 5 microns to about 15 microns. The screen printing process can be repeated as needed to apply the desired thickness. Two to four passes, usually three passes, have been observed to produce the optimum performance. After each application of the ink, the solvent is preferably removed by warming the electrode layer to about 50° C. to about 140° C., preferably about 75° C. A screen mask is used for forming an electrode layer having a desired size and configuration on the surface of the ion exchange membrane. The configuration is preferably a printed pattern matching the configuration of the electrode. The substances for the screen and the screen mask can be any materials having satisfactory strength such as stainless steel, poly(ethylene terephthalatey and nylon for the screen and epoxy resins for the screen mask.

After forming the catalyst coating, it is preferable to fix the ink on the surface of the membrane so that a strongly bonded structure of the electrode layer and the cation exchange membrane can be obtained. The ink may be fixed upon the surface of the membrane by any one or a combination of pressure, heat, adhesive, binder, solvent, electrostatic, and the like. Typically the ink is fixed upon the surface of the membrane by using pressure, heat or a combination of pressure and heat. The electrode layer is preferably pressed onto the surface of the membrane at about 100° C. to about 300° C., most typically about 150° C. to about 280° C., under a pressure of about 510 to about 51,000 kPa (about 5 to about 500 ATM), most typically about 1,015 to about 10,500 kPa (about 10 to about 100 ATM).

An alternative to applying the catalyst layer directly onto the membrane is the so-called “decal” process. In this process, the catalyst ink is coated, painted, sprayed or screen printed onto a substrate and the solvent is removed. The resulting “decal” is then subsequently transferred from the substrate to the membrane surface and bonded, typically by the application of heat and pressure.

When the binder polymer in the ink is in the precursor (sulfonyl fluoride) form, the catalyst coating after it is affixed to the membrane, either by direct coating or by decal transfer, is subjected to a chemical treatment (hydrolysis & acid exchange) where the binder is converted to the proton (or acid) form.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example 1

A 8″×8″ sample of 7mil commercial Nafion® membrane in acid form (N117, H⁺form, E. I. DuPont de Nemours, Wilmington, Del.) was placed in a zip-lock bag. A mixture containing 1.39 g of polyvinylpyrollidone (PVP) of molecular weight 1,300,000 g (Aldrich Chemicals) dissolved in 87.7 g of water and 87.7 g of tetrahydrofuran (THF) (Aldrich Chemicals) was prepared and poured into the zip-lock containing the above Nafion® membrane. The bag was zipped, placed on a flat surface and the mixture was evenly spread over the membrane. The membrane was kept in contact with the mixture for 2 hrs at room temperature. The bag was turned upside down and smoothed every 30 minutes to ensure the membrane was in contact with the mixture. After 2 hrs, the membrane was taken out and air dried for 15 mins, then was further hang-dried over night to drive off the remaining solvent. The next day it was further dried in a vacuum oven at 70° C. for about an hour with N₂ purging. The dried sample was cut into 4 pieces that were labeled samples 1, 2, 3, and 4. Two samples each were loaded in two separate aluminum shield packs and placed in a dry box. The shield packs were further purged with N₂ in the dry box for several hours and finally sealed with a bag sealer (Impulse Sealer, Type AIE-300C, American International Electric).

The next day, the sealed packs were removed from the dry box and stored in a container that was filled with dry ice. The samples were taken to the e-beam source (4.5 MV, 25 mA beam current). The packs containing samples 1 and 2 were treated with 20 Kgy total (two passes of 10 KGy), and the pack containing samples 3 and 4 were treated with 40Kgy total (two passes of 20 KGy). Dosage was comfirmed by film dosimetry technique at the equipment vendor (E-beam Services, Inc. Cranbury, CT). The samples were kept on dry ice during the e-beam dose to control heating. The treated samples in the Al packs were stored overnight in a container filled with dry ice, and the next day were heated in an oven at 70° C. for at least 1 hr. The Al packs was then opened and the samples were taken out. They were further treated in 15% KOH/water mixtures at 70° C. for about 45 mins, rinsed with water two times, and then soaked in 10% HNO₃ mixture for 45 mins. This step was repeated twice to ensure the K⁺ions were all replaced with H⁺within the membrane. They were further rinsed with deionized water 2 times and kept in contact with the water for 45 mins each until the water pH showed close to neutral. The catalyst were attached to the final membranes and then were tested in fuel cells.

Two control samples were also prepared as described above. Control Sample A was neat N 117 membrane (no PVP) with no e-beam treatment. Control Sample B was N 117 membrane with PVP, prepared as described above, but with no e-beam treatment.

The final membranes were all used in the CCM (catalyst coated membrane) fabrication described below and tested in fuel cells.

Catalyst Coated Membrane (CCM) Preparation Procedure:

After irradiation a catalyst layer was applied to each side of the films and the films hydrolyzed using the methods described in U.S. Pat. No. 5,330,860. These membrane-electrode assemblies had a final catalyst loading of approx. 4.0 mg Pt/cm² on the cathode and anode sides respectively. The anode catalyst was Pt-Ru black and cathode catalyst was Pt black, both purchased from Johnson Matthey, London, England.

The cathode catalyst dispersion was prepared in a Eiger® bead mill, manufactured by Eiger Machinery Inc., Grayslake, Ill 60030, containing 80 ml 1.0-1.25 micron zirconia grinding media. 105 grams platinum black catalyst powder and 336 grams of 3.5 wt % Nafione solution (the polymer resin used in the solution was typically 930 EW polymer and was in the sulfonyl fluoride form) were mixed and charged into the mill and dispersed for 2 hours. Material was withdrawn from the mill and particle size was measured. The ink was tested to ensure that the particle size was under 1-2 micron and the % solids in the range of 26%. The catalyst decal was prepared by drawing down the catalyst ink to a dimension of 5 cm×5 cm (to give a total area of 25 cm²) on a 10cm x 10 cm piece of 3 mil thick Kaptone polyimide film manufactured by E.I. duPont de Nemours & Co., Wilmington, Del. A wet coating thickness of 5 mil (125 microns) typically resulted in a catalyst loading of 4 to 5 mg Pt/cm² in the final CCM. Anode decals were prepared using a procedure similar to that described above, except that in the catalyst dispersion, the platinum black catalyst was replaced by a 1:1 atomic ratio platinum/ruthenium black catalyst powder. The CCM was prepared by a decal transfer method. The membranes (4″×4″) (10.16 cm×10.16 cm) in the H⁺form were used for CCM preparation. The membrane was sandwiched between an anode catalyst coated decal and a cathode catalyst coated decal. Care was taken to ensure that the coatings on the two decals were registered with each other and were positioned facing the membrane. The entire assembly was introduced between two pre-heated (1 60° C.) 8″×″8 (20.32 cm×20.32 cm) plates of a hydraulic press and the plates of the press were quickly brought together until a pressure of 6000 lbs (41 MPa) was reached. The sandwich assembly was kept under pressure for ˜2 mins and then the press was cooled for ˜2-3 mins (viz., untill it reached a temperature of <60° C.) under the same pressure. Then the pressure was released under ambient conditions, and the assembly was removed from the press and the Kapton® films were slowly peeled off from the top of the membrane showing that the catalyst coating had been transferred to the membrane. The CCM was immersed in a tray of water (to ensure that the membrane was completely wet) and carefully transferred to a zipper bag for storage and future use.

Chemical treatment of CCMs

The CCMs were chemically treated in order to convert the ionomer in the catalyst layer from the —SO₂F form to the proton —SO₃H form. This requires a hydrolysis treatment followed by an acid exchange procedure. The hydrolysis of the CCMs was carried out in a 20 wt % NaOH solution at 80° C. for 30 min. The CCM's were placed between Teflon® mesh, manufactured by DuPont, and placed in the solution. The solution was stirred to assure uniform hydrolyses. After 30 minutes in the bath, the CCM's were removed and rinsed completely with fresh deionized (Dl) water to remove all the NaOH.

Acid exchange of the CCMs that were hydrolyzed in the previous step was done in 15 wt % nitric acid solution at a bath temperature of 65° C. for 45 minutes. The solution was stirred to assure uniform acid exchange. This procedure was repeated in a second bath containing 15 wt % nitric acid solution at 65° C. for another 45 minutes.

The CCMs were then rinsed in flowing DI water for 15 minutes at room temperature to ensure removal of all the residual acid and finally in a water bath at 65° C. for 30 minutes. They were then packaged wet and labeled. The CCM comprised an untreated Nafion® 117 or treated Nafion® perfluorinated ion exchange membrane; and electrodes, prepared from a platinum/ ruthenium black catalyst and Nafion® binder on the anode side, and a platinum black catalyst and Nafion® binder on the cathode side.

The treated and untreated, 7 mil Nafion® membranes listed in Table 1 were evaluated for fuel cell performance in a cell employing a membrane electrode assembly, 30, (MEA) of the type depicted in FIG. 1. A catalyst coated membrane, 10, (CCM) prepared as described above was loosely attached in a single cell hardware (purchased from Fuel Cell Technologies Inc., NM) with GDB carbon cloths, 13. The carbon cloths were coated on both sides with microporous layers, with one side coated thicker than the other, and with the thicker coated side facing the Pt black electrode. The active area of the single cell hardware was 25 cm². Care was taken to ensure that the GDB covered the catalyst coated area on the CCM.

A glass fiber reinforced silicone rubber gasket (19) (Furan —Type 1007, obtained from Stockwell Rubber Company), cut to shape to cover the exposed area of the membrane of the CCM, was placed on either side of the CCM/GDB assembly, taking care to avoid overlapping of the GDB and the gasket material. The entire sandwich assembly was assembled between the anode and cathode flow field graphite plates (21) of a 25cm² standard single cell assembly (obtained from Fuel Cell Technologies Inc., Los Alamos, NM). The single cell assembly shown in FIG. 1 was also equipped with anode inlet (14), anode outlet (15), cathode gas inlet (16), cathode gas outlet (17), aluminum end blocks (18), tied together with tie rods (not shown), electrically insulating layer (20), and gold plated current collectors (22). The bolts on the outer plates (not shown) of the single cell assembly were tightened with a torque wrench to a torque of 1.5 ft.lb.

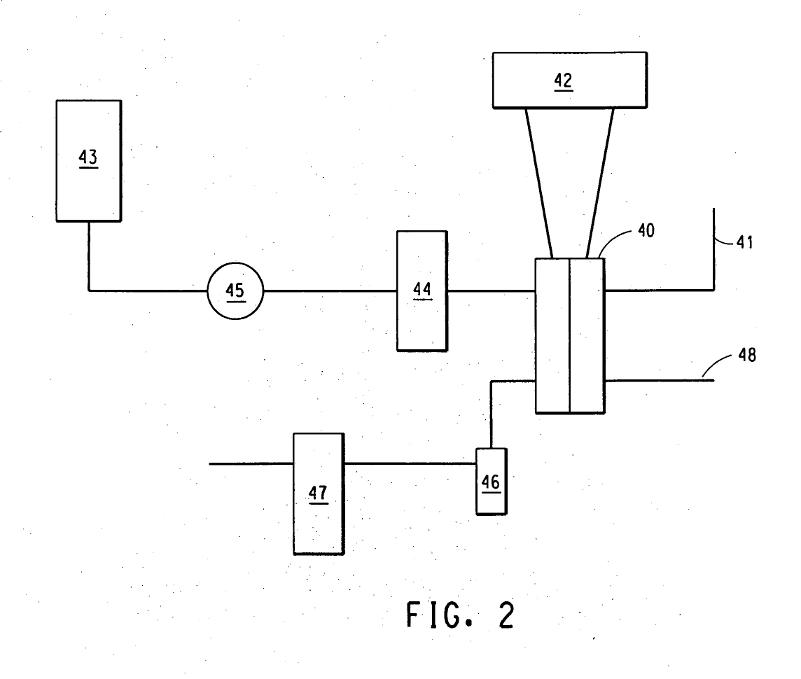

The single cell assembly (designated 40 in FIG. 2) was then connected to the fuel cell test station, a schematic illustration of which is shown in the FIG. 2. The components in a test station include a supply of air (41) for use as cathode gas; a load box (42) to regulate the power output from the fuel cell; a MeOH solution tank (43) to hold the feed anolyte solution; a heater (44) to pre-heat the MeOH solution before it enters the fuel cell; a liquid pump (45) to feed the anolyte solution to the fuel cell at the desired flow rate; a condenser (46) to cool the anolyte exit from the cell to room temperature, a collection bottle (47) to collect the spent anolyte solution, and a vent (48) through which exhaust gases and water are removed. The assembled single cell is attached to a battery cycler (Arbin Instruments, Model BT 2000, College Station, Tex. 77845) purchased from Arbin Instruments.

An aqueous solution of 1 M methanol was passed over the anode side and ambient pressure dry air at room temperature was passed over the cathode side at 4 and 3 methanol stoichiometric ratios respectively. The cell was heated to 70 ° C. The fuel cell performance was measured by discharging the cell (current drawn from the cell) from 0 to 315 mA/cm² and the and cell voltage was recorded. The cell power density (W/cm²), another performance measure, was calculated from the equation Power Density=Cell current density × Cell voltage.

The methanol crossover was measured using the method described by X. Ren et al (Methanol Cross-over in Direct Methanol Fuel Cells, The First International Symposium on Proton Conducting Membrane Fuel Cells, 1995: The Electrochemical Society 95-23: p. 284-298) at 40 and 60° C. by feeding 1.55 cc/min 1 M MeOH/water mixtures at anode and 255 cc/min dry nitrogen at cathode side of the cell.

The summary of results obtained using the above test protocols is detailed in Table 1. It can be seen that that average power density for the e-beam treated membranes of the invention decreased by 6.7% at 0.4V and increased by 16.6% at 0.45V versus both control membranes. It can also be seen that the average methanol crossover for the membranes of the invention decreased by 67% at 40° C. and by 66% at 60° C. versus the untreated N117 membrane, and decreased by 40% at40° C. and by 41% at 60° C. for the untreated N117/PVP membrane.

TABLE 1
Power Density & Methanol Crossover Data

| | | | | | MeOH Crossover at | |
|---|---|---|---|---|---|---|
| | | E-beam | Power Density at 70° C. | | Open Circuit Voltage | |
| | Membrane | Dosage, | (mW/cm²) | | (mA/cm²) | |
| Sample # | Descriptions | KGy | @ 0.4 V | @ 0.45 V | @ 40° C. | @ 60° C. |
| Control A | N117 - | 0 | 67.4 | 48 | 78.7 | 90.9 |
| | Control | | | | | |
| Control B | N117/PVP | 0 | 67.1 | 47 | 43.5 | 53 |
| | untreated | | | | | |
| 1 | N117/PVP | 40 | 58.9 | 48.7 | 32.9 | 39.7 |
| 2 | N117/PVP | 40 | 64.9 | 60.8 | 27.5 | 37.5 |
| 3 | N117/PVP | 20 | 72.8 | 66.1 | 22.6 | 26.2 |
| 4 | N117/PVP | 20 | 55.1 | 48.3 | 20.8 | 21.6 |

### Example 2

The same cell as described above was used to generate another set of fuel cell data using Sample 1, 2, and 3 and Control Sample A and B. This time the cell was heated to 60° C., the anode was fed with 1 .55 cc/min of 1 M MeOH/water mixtures and the cathode was fed with 255 cc/min dry air. The cell current of 3.75 A was drawn from the cell and the cell voltage was monitored. The methanol crossover decreased by 41% and 25% compared to the Control A & Control B samples respectively while the power density decreased by 10% and 8.2%.

What is claimed is:

1. A process to prepare a solid polymer electrolyte membrane comprising:
a) impregnating a film of an ionomer with a solution comprised of a polyamine, dissolved in a solvent for the polyamine; and
b) irradiating said film.

2. The process of claim 1 wherein the ionomer is a fluorinated ionomer.

3. The process of claim 1 wherein the polyamine is a polyvinyl amine, amides, imine, and imide, or derivatives thereof.

4. The process of claim 3 wherein the polyamine is polyvinylpyrrolidone or polyethyleneimine.

5. The process of claim 1 wherein the ionomer is a highly fluorinated sulfonic acid polymer.

6. The process of claim 5 wherein the highly fluorinated sulfonic acid polymer comprises a highly fluorinated carbon backbone and a side chain represented by the formula —(OCF₂CFR_{f})ₐ—OCF₂CFR′_{f}SO₂F, wherein R_{f} and R′_{f} are independently selected from F, Cl or a perfluorinated alkyl group having 1 to 10 carbon atoms, and a =0, 1 or 2.

7. The process of claim 6 wherein the highly fluorinated sulfonic acid polymer comprises a perfluorocarbon backbone and the side chain is represented by the formula —O—CF₂CF(CF₃)—O—CF₂CF₂SO₂F.

8. The process of claim 1 wherein the ionomer is in ionic or acid form before the impregnation of step a).

9. The process of claim 1 wherein the radiation dose is about 1 to 150kGy.

10. The process of claim 1 wherein the polyamine is present in an amount of about 0.1% to 25% by weight based on the weight of the film after step a).

11. The process of claim 1 wherein step a) is conducted at a temperature of about 100° C.

12. The process of claim 1 wherein step a) is conducted at room temperature.

13. The process of claim 1 wherein the solvent is water or a mixture of water and tetrahydrofuran.

14. A membrane made by the process of claim 1.

15. A membrane and electrode assembly comprising a layer containing electrically conductive, catalytically active particles formed on the surface of a membrane made by the process of claim 1.

16. The membrane of claim 14 wherein the polyamine is a polyvinyl amine, amide, imine, or imide, or derivatives thereof.

17. The membrane claim 16 wherein the polyamine is polyvinylpyrrolidone or polyethyleneimine.

18. The membrane of claim 14 wherein the ionomer is a highly fluorinated sulfonic acid polymer.

19. The membrane of claim 18 wherein the highly fluorinated sulfonic acid polymer comprises a highly fluorinated carbon backbone and a side chain represented by the formula —(OCF₂CFR_{f})ₐ—OCF₂CFR′_{f}SO₂F, wherein R_{f} and R′_{f} are independently selected from, F, CI or a perfluorinated alkyl group having 1 to 10 carbon atoms, and a =0, 1 or 2.

20. The membrane of claim 18 wherein the highly fluorinated sulfonic acid polymer comprises a perfluorocarbon backbone and the side chain is represented by the formula —O—CF₂CF(CF₃)—O—CF₂CF₂SO₂F.

21. The membrane of claim 14 wherein the ionomer is hydrolyzed and acid exchanged.

22. An electrochemical cell comprising the membrane made by the process of claim 1.

23. The electrochemical cell of claim 22 that is a fuel cell.
